(19) United States
(12) Patent Application Publication
(10) Pub. No.: US 2014/0095194 A1
(43) Pub. Date: Apr. 3, 2014

(54) Method and Apparatus For Payment of HealthCare Costs and Associated Health Care Credit Card

(71) Applicants: Robert G. Mahaffey, Las Vegas, NV (US); Rulx Ganthier, JR., Lake Placid, FL (US)

(72) Inventors: Robert G. Mahaffey, Las Vegas, NV (US); Rulx Ganthier, JR., Lake Placid, FL (US)

(21) Appl. No.: 14/045,144

(22) Filed: Oct. 3, 2013

Related U.S. Application Data
(60) Provisional application No. 61/709,226, filed on Oct. 3, 2012.

(51) Int. Cl. G06Q 50/22; G06Q 30/02; G06Q 20/34

(52) U.S. Cl. CPC G06Q 50/22; G06Q 20/34; G06Q 30/0207
USPC 705/2

(57) ABSTRACT

A method by which a consumer pays for services provided by a service provider with a payment card issued by a payment card provider. The method comprises: using the payment card, the consumer paying the amount due for the services less a discount amount, wherein a discount table agreed to by the payment card provider and the service provider indicates for each one of a plurality of discount amounts an incentive fee payable to the payment card provider; the payment card provider paying the healthcare provider the amount due less the discount and less the incentive fee; and the payment card provider debiting a payment account of the consumer with the amount due less the discount.

This patent application claims the benefit of the U.S. provisional patent application filed on Oct. 3, 2012 and assigned Application No. 61/709,226, which is incorporated herein.

### FIELD

This invention relates generally to the field of healthcare services, and more specifically to a method for paying for healthcare services.

### BACKGROUND

With rising healthcare costs and increasing patient visits, today's healthcare providers often retain significant accounts receivable for the services provided. The time lag between provision of the service and reimbursement by the insurance carrier, as well as delays in receiving the payment from the patient for any amounts for which she is responsible, strain the revenue stream of healthcare providers. The cost of administering and collecting these accounts receivable represents a considerable resource allocation for the provider. Also, the carrying costs generated by these receivables represent a sizable expense for the provider. All healthcare providers, including hospitals, physicians, laboratories, ambulatory surgery centers, diagnostic centers and clinics are subject to these costs of doing business.

Typically, when a patient receives healthcare services, she is expected to pay any amount not covered by insurance at the time the services are rendered. The payment is generally in the form of a personal check drawn on the patient's bank account, by credit card, or by debit card. In the former case, the check can take several days to clear before the corresponding deposit is made into the provider's bank account. Credit card transactions are typically processed faster and thus the deposit is credited to the provider's account earlier than payments by check. Cash payments result in immediate revenue to the provider, but today, few patients pay for their healthcare services with cash.

The healthcare provider processes the credit card payment, thereby notifying the credit card issuer that the patient has charged the amount due to the credit card. Within a few days this amount is debited to the patient's account and the provider's bank account is credited with the amount charged by the patient. The transaction is finally concluded when the patient pays the credit card issuer for the healthcare service. If this payment from the patient is not received within an allotted time, interest charges are assessed against the card holding patient.

### BRIEF DESCRIPTION OF THE DRAWINGS

The present invention can be more easily understood and the further advantages and uses thereof more readily apparent, when considered in view of the following detailed description when read in conjunction with the following figures. In accordance with common practice, the various described features are not drawn to scale, but are drawn to emphasize specific features relevant to the invention. Reference characters denote like elements throughout the figures and text.

FIG. 1 is a flowchart representing a method of one embodiment of the present invention.

FIG. 2 is a block diagram of an apparatus for implementing one embodiment of the method of FIG. 1.

### DETAILED DESCRIPTION OF THE PREFERRED EMBODIMENTS

Before describing in detail the particular methods and apparatuses related to paying for health care costs, it should be observed that the embodiments of the present invention reside primarily in a novel and non-obvious combination of elements and process steps. So as not to obscure the disclosure with details that will be readily apparent to those skilled in the art, certain conventional elements and steps have been presented with lesser detail, while the drawings and the specification describe in greater detail other elements and steps pertinent to understanding the embodiments. The presented embodiments are not intended to define limits as to the structures, elements or methods of the inventions, but only to provide exemplary constructions. The embodiments are permissive rather than mandatory and illustrative rather than exhaustive.

As used herein, a payment card refers to any of the following card types or any similar vehicle for making payment by a consumer to a vendor: credit card, debit card, ATM card, charge card, stored-value card, and fleet card.

The embodiments relate to a method using a healthcare payment card that offers financial assistance (e.g., in the form of a discount) to healthcare consumers when they use the medical services of an enrolled healthcare providers (i.e., a health care provider having a business relationship with the healthcare payment card issuer). Any healthcare provider, e.g., hospital, physician, surgery center, diagnostic center, funeral home, home health company, physical therapy/rehabilitation facility and nursing home is eligible to enroll in the plan. Those consumers who use the healthcare payment card include anyone qualifying for the payment card through the financial institution that issues the card.

A healthcare provider contracts with a payment card provider or issuer (PCP) and selects a discount percentage the provider wishes to offer to its patients. After the contract is initiated, each healthcare provider is supplied with a special card swipe machine that automatically discounts the provided service based on the selected contract discount. Contracts will only be provided to healthcare providers who are in good standing with applicable federal and state regulations.

Consumers can apply for the healthcare payment card as they do any other credit or debit card. The payment card can be used when services are provided by any healthcare provider who is enrolled in the program and under contract with the PCP of the healthcare payment card.

The method is described below.

A patient uses the services of a healthcare provider who participates in the HEALTH+™ Program, an exemplary name for the program described herein.

The patient is billed, for example, $500.00 for services rendered. After insurance and co-payments are applied, the patient has an out-of-pocket expense of $100.00. The patient uses his HEALTH+™ payment card to pay the remaining balance of $100.00.

But before payment by the patient, a discount is applied to the payment card payment. The discount amount is selected by the healthcare provider and designated in the contract between the PCP and the healthcare provider.

Discount/Incentive Table:

10% discount to patient and a 10% incentive to credit card provider
(CCP).
15% discount to patient and a 9% incentive to PCP
20% discount to patient and a 8% incentive to PCP
25% discount to patient and a 7% incentive to PCP
30% discount to patient and a 6% incentive to PCP
35% discount to patient and a 5% incentive to PCP
40% discount to patient and a 4% incentive to PCP
45% discount to patient and a 3% incentive to PCP
50% discount to patient and a 2% incentive to PCP

In the above example the patient has a $100.00 out of pocket expense. Assuming the service provider/PCP contract designates a 10% patient discount, the PCP then invoices the patient $90.00 ($100 less a 10% discount). Upon receipt of the $90 from the patient through use of the HEALTH+™ card, the PCP pays the healthcare provider $80.00, thus receiving a 10% incentive as set forth in the table above. The 10% bonus or incentive compensates the PCP for assuming the risk regarding the patient's payment of the healthcare provider's bill.

As can be seen from the table above, the smaller the discount provided to the patient the larger the incentive provided to the PCP. The incentive decreases as the discount increases because the PCP assumes less risk.

BENEFITS OF THE HEALTH+™ PAYMENT CARD

This invention presents a desired process to help healthcare consumers cope with the rising cost of healthcare, whether the Patient Protection and Affordable Care Act continues to exist partially or entirely or if it is eventually stricken or completely changed. Healthcare consumers who take advantage of the HEALTH+™ payment card will receive a discount for health care services, providing an economical process for financing one of the most important and expensive aspects of their lives, that is, their health.

The financial institution that develops the payment card creates an innovative low cost system with a perpetual revenue stream and access to additional sources of revenue, i.e., cell phone application (apps), cloud technology.

The healthcare providers receive benefits from reduced expenses associated with materials, postage, in house and outsourcing of cash collection efforts and in return will save millions of dollars that will lower healthcare costs to the consumers.

In light of the ability of retailers/businesses to add a surcharge (1.5%-3%) for certain credit card transactions, the HEALTH+™ payment card should be an especially welcome new product for the consumer.

Use of the HEALTH+™ system will reward all healthcare providers who maintain good standing in their professional fields thus improving the quality of care offered to their patients and economic success in the growth of their business.

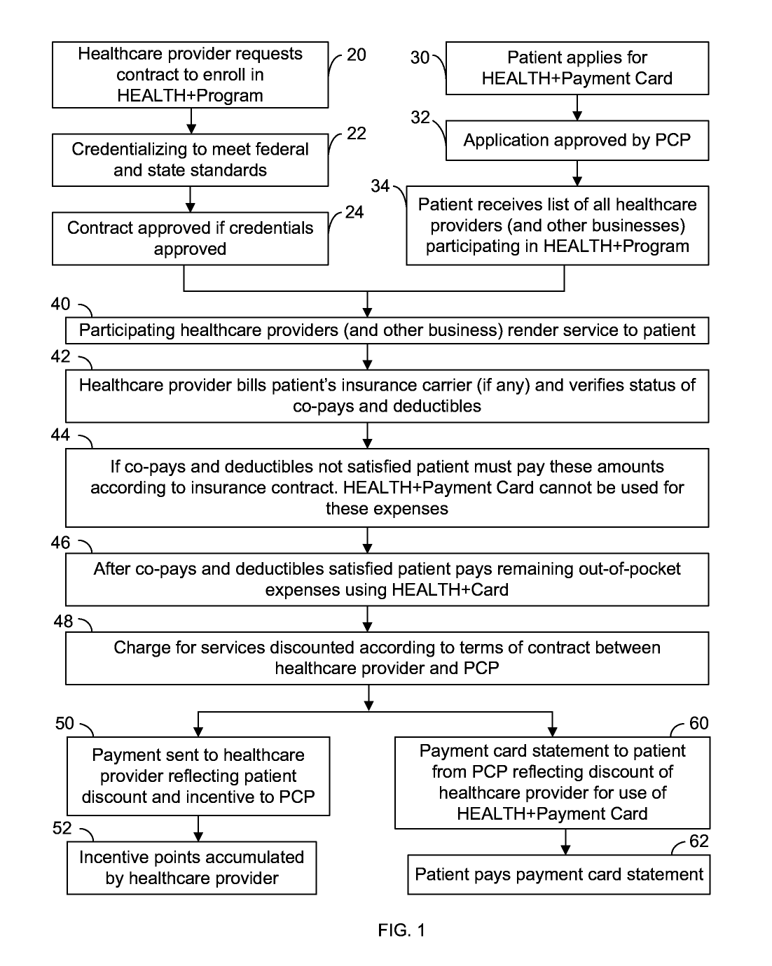

The flow chart of FIG. 1 further illustrates the method of the present invention.

At a step 20 a healthcare provider requests a contract with a PCP to enroll in the HEALTH+™ program. Credentialing of the healthcare provider occurs at a step 22 and a contract between the approved healthcare provider and the PCP is approved at a step 26.

Turing to the right side of FIG. 1, at a step 30 a patient applies for a HEALTH+ payment card and the application is approved at a step 32. At a step 34 the patient receives a list of all healthcare providers participating in the HEALTH+™ program or a list of other businesses participating in a similar program.

At a step 40 enrolled healthcare providers provide a service to the patient. At a step 42 the healthcare provider bills the patient and determines the status of any co-pay and deductible amounts. A step 44 indicates that any co-pay and deductible amounts that are not satisfied must be paid by the patient, as according to one embodiment the HEALTH+™ payment card cannot be used for those expenses.

At a step 46 the patient pays the remaining out-of-pocket amount using the HEALTH+™ payment card. A step 48 indicates that the actual out-of-pocket charge to the patient is discounted according to the discount schedule in the contract between the healthcare provider and the PCP.

At a step 50 a payment is sent to the healthcare provider by the PCP. This amount reflects the discount provided to the patient and the incentive to the PCP. At a step 52 in one embodiment incentive points may be accumulated by the healthcare provider.

In an application where the payment card is a credit card, a credit card statement is sent to the patient from the PCP at a step 60. This statement reflects the discount to the patient for use of the HEALTH+™ payment card. At a step 62 the patient pays the credit card statement.

Although the steps associated with the method of FIG. 1 have been described in the context of a patient and healthcare provider, the teachings of the present invention cal also be applied to other businesses that supply goods or services to members of the public.

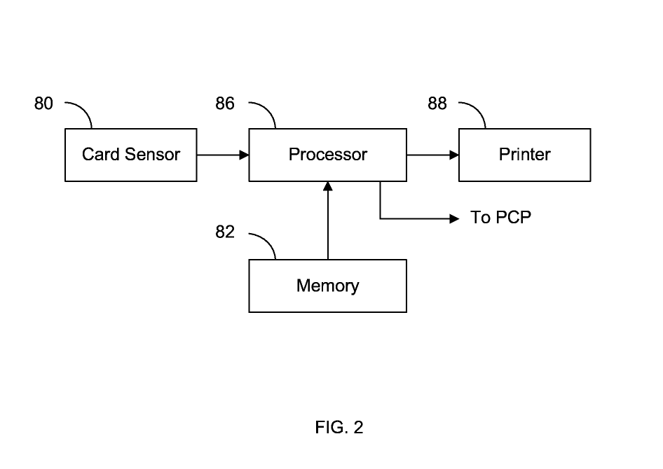

Another aspect of the invention comprises a card swipe machine that implements the discount amount agreed to between the PCP and the healthcare provider. A block diagram of a card wipe machine is set forth in FIG. 2. A card sensor 80 reads the card and determines the identity of the patient. The discount amount is stored in a memory 82 and a processor calculates the amount due based on that discount amount. The discount amount had been previously agreed to and set forth in the contract between the healthcare provider and the PCP. Storing this discount amount and programming the swipe machine to implement the agreed discount eliminates errors that might occur if the discount amount was manually entered for each transaction. This feature also eliminates discrimination in the applied discount, where, for example, the healthcare provider offers a first discount to certain patients and a second lower discount to other patients.

A processor 86, responsive to the memory 82 and the card sensor 80, calculates the amount due from the patient and a printer 88 prints a receipt after payment of the amount due. The amount due is also sent to the PCP for use in preparing the patient's statement.

At the end of each year the system/swipe card machine provides a statement to the healthcare providers indicating the discounts provided during the year and also the earned incentive (referred to at the step 52 of FIG. 1).

In another embodiment, the discount scheme of the present invention can be applied to the payment of deductible and co-pay amounts upon approval of the insurance carrier.

As described above, in a preferred embodiment the healthcare provider decides the amount of discount granted to the PCP in return for the PCP bearing the risk of non-payment by the patient.

Beneficially, the method of the present invention and its swipe card machine eliminates the cost of collection efforts by healthcare providers, which in turn will reduce healthcare expenses.

Since only healthcare providers who have contracted with a PCP will be using the method of the present invention, regional lists of those providers can be provided to patients, who would then be encouraged to use the listed providers.

The discount method and associated card may be beneficial to new physicians to use in attracting new patients.

The card and its attendant discount methodology can be used not only by physicians in private practice, but also hospital-based physicians such as pathologists, radiologist, anesthesiologists, and emergency room physicians.

Use of the card by patients can be used to track revenue and market data.

Employers can offer the card to employees as a component of the benefits package.

The PCP may offer the card to patients with no fee (e.g., no annual fee) or there may be a fee associated with the card.

Although described in the context of a patient/healthcare provider, the method of the present invention can also be applied to the following services: retail, transportation, industrial, food/restaurants, farming, construction/development, other financial/banking transactions.

When the present invention is applied to debit cards, the PCP assumes a lower risk than with a credit card and thus the PCP discount should be appropriately smaller.

As applied to the medical field, the present invention has been described in the context of traditional healthcare providers, such as physicians in private practice. But the various embodiments of the invention can also be practiced by pharmacists, hospitals, rehabilitation centers, nursing homes, diagnostic centers, medical spas, hospice caregivers, funeral homes, etc. As applied to the flow chart of FIG. 1, these businesses must also be determined to be in “good standing” before contracting with the card issuing company.

While the invention has been described with reference to preferred embodiments, it will be understood by those skilled in the art that various changes may be made and equivalent elements may be substituted for elements thereof without departing from the scope of the present invention. The scope of the present invention further includes any combination of the elements from the various embodiments set forth. In addition, modifications may be made to adapt a particular situation to the teachings of the present invention without departing from its essential scope. Therefore, it is intended that the invention not be limited to the particular embodiment disclosed as the best mode contemplated for carrying out this invention, but that the invention will include all embodiments falling within the scope of the appended claims.

What is claimed is:

1. A method by which a consumer pays for services provided by a service provider with a payment card issued by a payment card provider, the method comprising:
(a) using the payment card, the consumer paying the amount due for the services less a discount amount, wherein a discount table agreed to by the payment card provider and the service provider indicates for each one of a plurality of discount amounts an incentive fee payable to the payment card provider;
(b) the payment card provider paying the healthcare provider the amount due less the discount and less the incentive fee; and
(c) the payment card provider debiting a payment account of the consumer with the amount due less the discount.

2. The method of claim 1 wherein the services comprise healthcare services and wherein the provider comprises a healthcare provider.

3. The method of claim 1 wherein the payment card comprises a credit card, a debit card, an ATM card, a charge card, a stored-value card, or a fleet card.

4. The method of claim 1 wherein the services comprise non healthcare related services.

5. The method of claim 1 wherein the amount due comprises a co-pay amount or a deductible amount.

6. The method of claim 1 further comprising a step of credentialing the service provider before the discount tables is agreed to.

7. An apparatus for use in a payment card transaction related to a consumer purchasing goods or services from a provider, the payment card previously issued by an issuing party, the apparatus comprising:
a first component for receiving the payment card information to make a payment for services rendered;
a second component for determining the amount due for the services, wherein the amount due is responsive to the services and a selected discount amount;
a third component for debiting the amount due from an account of the consumer; and
a fourth component for paying the provider an amount responsive to the amount due, the selected discount, and an incentive fee due the issuing party, the incentive fee responsive to the discount amount.

8. The apparatus of claim 7 wherein the services comprise healthcare services and wherein the provider comprises a healthcare provider.

9. The apparatus of claim 7 wherein the payment card comprises a credit card, a debit card, an ATM card, a charge card, a stored-value card, or a fleet card.

10. The apparatus of claim 7 wherein the services comprise non healthcare related services.

11. The apparatus of claim 7 wherein the amount due comprises a co- pay amount or a deductible amount.

12. The apparatus of claim 7 further comprising a step of credentialing the service provider before the discount tables is selected.
